(19) United States
(12) Patent Application Publication
(10) Pub. No.: US 2024/0268255 A1
(43) Pub. Date: Aug. 15, 2024

(54) ADAPTER ASSEMBLY FOR A HOPPER OF AN AGRICULTURAL ROW UNIT

(71) Applicants: CNH Industrial America LLC, New Holland, PA (US); CNH Industrial Canada, Ltd., Saskatoon (CA)

(72) Inventors: Chad Michael Johnson, Arlington Heights, IL (US); Mayur Kishorchandra Joshi, Saskatoon (CA)

(21) Appl. No.: 18/435,246

(22) Filed: Feb. 7, 2024

Related U.S. Application Data
(60) Provisional application No. 63/445,212, filed on Feb. 13, 2023.

(51) Int. Cl. A01C 7/20

(52) U.S. Cl. CPC A01C 7/201

(57) ABSTRACT

An adapter assembly for a hopper of an agricultural row unit includes an adapter configured to be disposed at least partially about an outlet of the hopper. The adapter is movable along the outlet of the hopper to a vertical position to establish vertical alignment between an outlet of an agricultural product meter and an inlet of an agricultural product conveying system, the adapter is configured to be coupled to the hopper at the vertical position along the outlet of the hopper, the adapter comprises an alignment feature configured to engage a corresponding alignment feature of a mounting component to position the mounting component relative to the outlet of the hopper with respect to a longitudinal axis and a lateral axis. The mounting component includes an agricultural product meter or a receiver configured to engage the agricultural product meter.

### CROSS-REFERENCE TO RELATED APPLICATION

This application claims priority from and the benefit of U.S. Provisional Application Ser. No. 63/445,212, entitled “ADAPTER ASSEMBLY FOR A HOPPER OF AN AGRICULTURAL ROW UNIT”, filed Feb. 13, 2023, which is hereby incorporated by reference in its entirety.

### BACKGROUND

The present disclosure relates generally to an adapter assembly for a hopper of an agricultural row unit.

Generally, planting implements (e.g., planters) are towed behind a tractor or other work vehicle. Planting implements typically include multiple row units distributed across a width of the implement. Each row unit is configured to deposit agricultural product (e.g., seed, fertilizer, etc.) at a desired depth beneath the soil surface of a field, thereby establishing rows of planted agricultural product. For example, each row unit typically includes a ground engaging tool or opener that forms a trench for agricultural product deposition into the soil. An agricultural product conveying system (e.g., agricultural product tube or powered agricultural product conveyor) is configured to deposit agricultural product (e.g., seed, fertilizer, etc.) into the trench. The opener/agricultural product conveying system may be followed by closing discs that move displaced soil back into the trench and/or a packer wheel that packs the soil on top of the deposited agricultural product.

Each row unit of the planting implement may include an agricultural product meter (e.g., vacuum agricultural product meter, etc.) configured to control a flow rate of the agricultural product (e.g., seed, fertilizer, etc.) to the agricultural product conveying system, thereby establishing a desired distribution of the agricultural product throughout the field. In certain row unit configurations, the agricultural product meter is coupled to a hopper configured to store the agricultural product. Certain hoppers are formed by a rotational molding process, which may cause dimensional variations throughout the hopper. Accordingly, an outlet of the hopper may not be accurately aligned with an inlet of the agricultural product meter. As a result, the agricultural product may accumulate at the interface between the hopper and the agricultural product meter, thereby interfering with flow of the agricultural product from the hopper to the agricultural product meter.

### BRIEF DESCRIPTION

In certain embodiments, an adapter assembly for a hopper of an agricultural row unit includes an adapter configured to be disposed at least partially about an outlet of the hopper. The adapter is movable along the outlet of the hopper to a vertical position to establish vertical alignment between an outlet of an agricultural product meter and an inlet of an agricultural product conveying system, the adapter is configured to be coupled to the hopper at the vertical position along the outlet of the hopper, the adapter comprises an alignment feature configured to engage a corresponding alignment feature of a mounting component to position the mounting component relative to the outlet of the hopper with respect to a longitudinal axis and a lateral axis. The mounting component includes an agricultural product meter or a receiver configured to engage the agricultural product meter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement having multiple row units distributed across a width of the agricultural implement;

FIG. 2 is a side view of an embodiment of a row unit that may be employed on the agricultural implement of FIG. 1;

FIG. 3 is a right perspective view of an embodiment of an adapter assembly that may be employed within the row unit of FIG. 2;

FIG. 4 is a left perspective view of the adapter assembly of FIG. 3;

FIG. 5 is a cross-sectional view of the adapter assembly of FIG. 3;

FIG. 6 is a side view of a portion of the adapter assembly of FIG. 3; and

FIG. 7 is a perspective view of a portion of the row unit of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

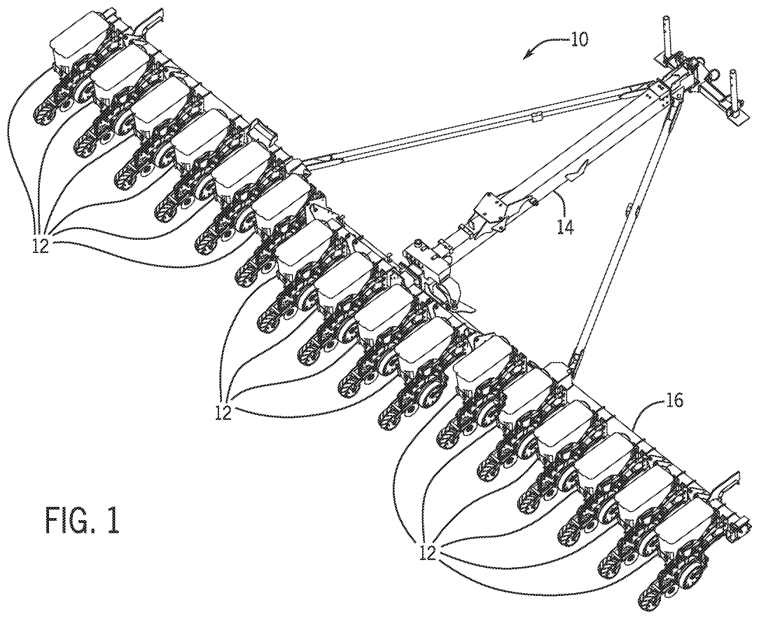

FIG. 1 is a perspective view of an embodiment of an agricultural implement 10 (e.g., planting implement) having multiple row units 12 distributed across a width of the agricultural implement 10. The implement 10 is configured to be towed through a field behind a work vehicle, such as a tractor. As illustrated, the implement 10 includes a tongue assembly 14, which includes a hitch configured to couple the implement 10 to an appropriate tractor hitch (e.g., via a ball, clevis, or other coupling). The tongue assembly 14 is coupled to a tool bar 16 which supports multiple row units 12. Each row unit 12 may include one or more opener discs configured to form a trench within soil of a field. The row unit 12 may also include an agricultural product conveying system (e.g., agricultural product tube or powered agricultural product conveyer) configured to deposit agricultural product (e.g., seed, fertilizer, etc.) into the trench. In addition, the row unit 12 may include closing disc(s) and/or a packer wheel positioned behind the agricultural product conveying system. The closing disc(s) are configured to move displaced soil back into the trench, and the packer wheel is configured to pack soil on top of the deposited agricultural product.

As discussed in detail below, each row unit 12 of the agricultural implement 10 includes an agricultural product meter (e.g., vacuum agricultural product meter) and a hopper. The agricultural product meter is configured to control a flow rate of the agricultural product (e.g., seed, fertilizer, etc.) to the agricultural product conveying system, thereby controlling the flow rate of the agricultural product into the trench. As a result, a desired distribution of the agricultural product throughout the field (e.g., a desired seed spacing along a respective seed row) may be established.

In certain embodiments, at least one row unit 12 of the agricultural implement 10 includes an adapter assembly configured to facilitate coupling the hopper to the agricultural product meter. As discussed in detail below, the adapter assembly includes an adapter configured to be disposed at least partially about an outlet of the hopper. The adapter is configured to be coupled to the hopper at the outlet, and the adapter includes an alignment feature configured to engage a corresponding alignment feature of a receiver to position the receiver relative to the outlet with respect to a longitudinal axis and a lateral axis. Furthermore, the adapter is configured to couple to the receiver, and the receiver is configured to couple the hopper to the agricultural product meter. By controlling the vertical position of the adapter along the outlet of the hopper, the agricultural product meter may be located at an accurate vertical position relative to a frame of the row unit 12, thereby establishing an accurate vertical alignment between an outlet of the agricultural product meter and an inlet of the agricultural product conveying system. Furthermore, the adapter enables a hopper that does not include an alignment feature to engage a receiver having the corresponding alignment feature. As a result, a single receiver may be used for hoppers with and without an alignment feature, thereby reducing costs associated with designing an manufacturing different receivers for different hoppers.

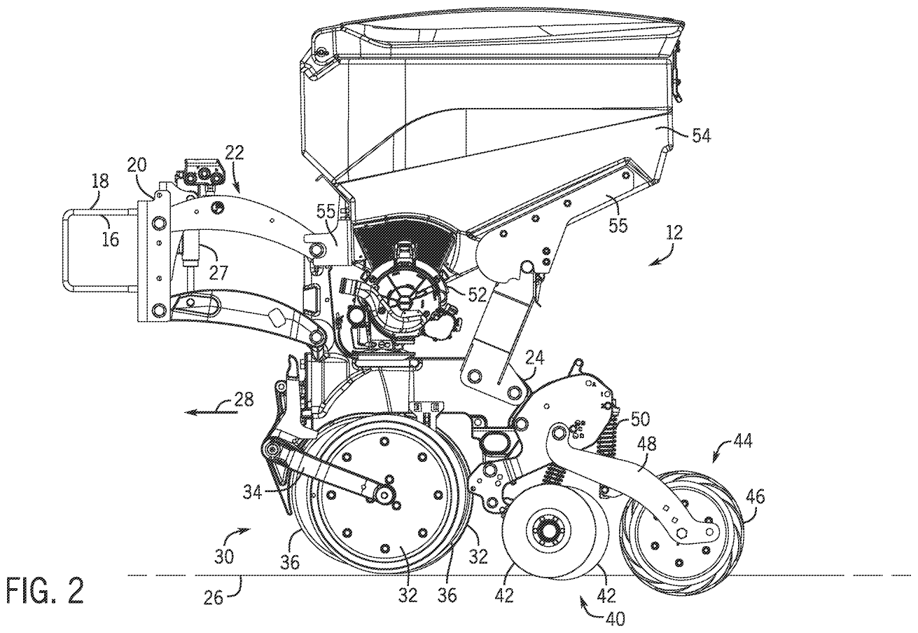

FIG. 2 is a side view of an embodiment of a row unit that may be employed on the agricultural implement of FIG. 1. The row unit 12 includes a mount 18 configured to secure the row unit 12 to the tool bar 16 of the agricultural implement. In the illustrated embodiment, the mount 18 includes a U-bolt that secures a bracket 20 of the row unit 12 to the tool bar 16. However, in alternative embodiments, the mount may include another suitable device that couples the row unit to the tool bar. A linkage assembly 22 extends from the bracket 20 to a frame 24 of the row unit 12. The linkage assembly 22 is configured to enable vertical movement of the frame 24 relative to the tool bar 16 in response to variations in a soil surface 26. In the illustrated embodiment, an actuator 27 (e.g., hydraulic actuator, pneumatic actuator, electromechanical actuator, etc.) is configured to urge the frame 24 toward the soil surface 26. While the illustrated linkage assembly 22 is a parallel linkage assembly (e.g., a four-bar linkage assembly), in other embodiments, another suitable linkage assembly may extend between the bracket and the frame.

The row unit 12 is configured to deposit agricultural product (e.g., seed, fertilizer, etc.) at a target depth beneath the soil surface 26 as the row unit 12 traverses a field along a direction of travel 28. The row unit 12 includes an opener assembly 30 that forms a trench in the soil for agricultural product deposition into the soil. In the illustrated embodiment, the opener assembly 30 includes gauge wheels 32, arms 34 that pivotally couple the gauge wheels 32 to the frame 24, and opener discs 36. The opener discs 36 are configured to excavate a trench into the soil, and the gauge wheels 32 are configured to control a penetration depth of the opener discs 36 into the soil. In certain embodiments, the row unit 12 includes a depth control system configured to control the vertical position of the gauge wheels 32 (e.g., by blocking rotation of the arms in the upward direction beyond a selected orientation), thereby controlling the penetration depth of the opener discs 36 into the soil. While the opener assembly 30 includes opener discs 36 in the illustrated embodiment, in other embodiments, the opener assembly may include any other suitable opener(s) (e.g., knife blade opener(s), coulter(s), etc.) configured to form the trench in the soil.

The row unit 12 also includes an agricultural product conveying system (e.g., seed tube or powered agricultural product conveyor) configured to deposit agricultural product (e.g., seed, fertilizer, etc.) into the trench. The opener assembly 30 and the agricultural product conveying system are followed by a closing assembly 40 that moves displaced soil back into the trench. In the illustrated embodiment, the closing assembly 40 includes two closing discs 42. However, in other embodiments, the closing assembly may include other suitable closing device(s) (e.g., a single closing disc, etc.). In addition, in certain embodiments, the closing assembly may be omitted. In the illustrated embodiment, the closing assembly 40 is followed by a packing assembly 44 configured to pack soil on top of the deposited agricultural product. The packing assembly 44 includes a packer wheel 46, an arm 48 that pivotally couples the packer wheel 46 to the frame 24, and a biasing member 50 configured to urge the packer wheel 46 toward the soil surface 26, thereby enabling the packer wheel to pack soil on top of the deposited agricultural product. While the illustrated biasing member 50 includes a spring, in other embodiments, the biasing member may include another suitable biasing device, such as a hydraulic cylinder or a pneumatic cylinder, among others. Furthermore, in certain embodiments, the packing assembly may be omitted.

The row unit 12 includes an agricultural product meter 52 configured to receive agricultural product (e.g., seeds, fertilizer, etc.) from a hopper 54. In the illustrated embodiment, the agricultural product meter 52 includes a vacuum seed meter, which includes a disc having multiple openings. An air pressure differential between opposite sides of the disc induces the agricultural product (e.g., seeds, fertilizer, etc.) to be captured within the openings. As the disc rotates, the agricultural product is conveyed toward the agricultural product conveying system. When the agricultural product (e.g., seed, fertilizer, etc.) is aligned with an inlet of the agricultural product conveying system, the air pressure on each side of the disc is substantially equalized (e.g., at the end of a vacuum passage), thereby enabling the agricultural product (e.g., seed, fertilizer, etc.) to enter the agricultural product conveying system (e.g., agricultural product tube or powered agricultural product conveyor). The agricultural product conveying system then directs the agricultural product to the trench. While the agricultural product meter includes a vacuum seed meter in the illustrated embodiment, in other embodiments, other suitable agricultural product meters may be utilized. As used herein, “vacuum” refers to an air pressure that is less than the ambient atmospheric air pressure, and not necessarily 0 pa.

To assemble the row unit 12, the agricultural product meter 52 is coupled to the hopper 54 to form a hopper/agricultural product meter assembly, and the hopper/agricultural product meter assembly is then coupled to the frame 24 of the row unit 12. In the illustrated embodiment, the row unit includes brackets 55 coupled to the hopper 54 and configured to couple the hopper, with the agricultural product meter attached, to the frame 24. In certain embodiments, the hopper 54 is formed by a rotational molding process, which may cause dimensional variations throughout the hopper. Accordingly, the brackets 55 may be accurately positioned on the hopper 54 with respect to an outlet of the hopper (e.g., coupled to the hopper with fasteners), such that the outlet is accurately located with respect to the row unit frame 24 while the hopper/agricultural product meter assembly is coupled to the frame 24.

As discussed in detail below, the row unit 12 includes an adapter assembly configured to facilitate coupling the hopper to the agricultural product meter. The adapter assembly includes an adapter configured to be disposed at least partially about the outlet of the hopper. The adapter is configured to be coupled to the hopper at the outlet, and the adapter includes an alignment feature configured to engage a corresponding alignment feature of a receiver to position the receiver relative to the outlet with respect to a longitudinal axis and a lateral axis. Furthermore, the adapter is configured to couple to the receiver, and the receiver is configured to couple the hopper to the agricultural product meter. By controlling the vertical position of the adapter along the outlet of the hopper 54, the agricultural product meter may be located at an accurate vertical position relative to the frame 24 of the row unit 12, thereby establishing an accurate vertical alignment between an outlet of the agricultural product meter 52 and an inlet of the agricultural product conveying system. Furthermore, the adapter enables a hopper that does not include an alignment feature to engage a receiver having the corresponding alignment feature. As a result, a single receiver may be used for hoppers with and without an alignment feature, thereby reducing costs associated with designing an manufacturing different receivers for different hoppers.

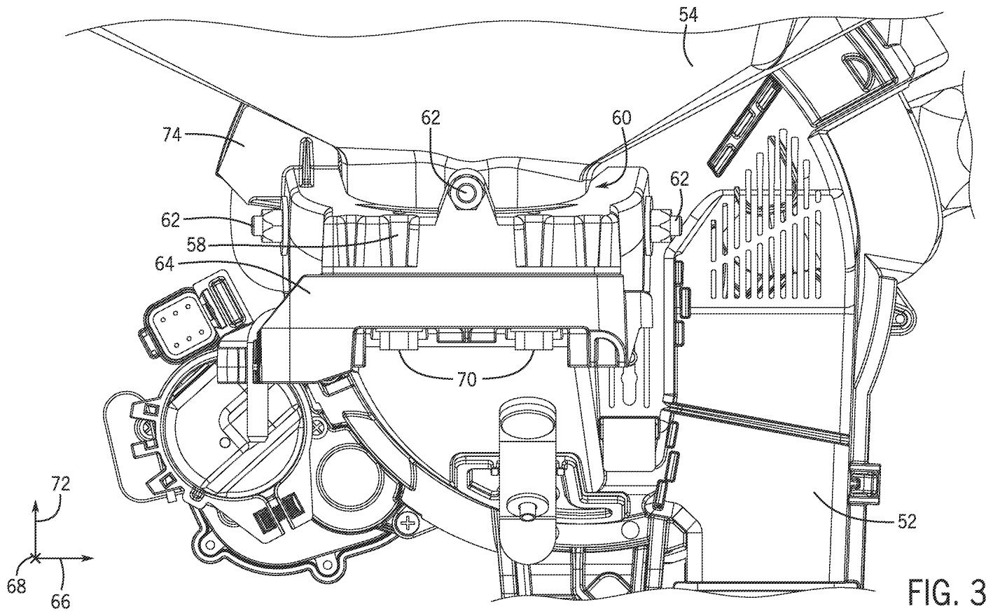

FIG. 3 is a right perspective view of an embodiment of an adapter assembly 56 that may be employed within the row unit of FIG. 2. As previously discussed, the adapter assembly 56 is configured to facilitate coupling the hopper 54 to the agricultural product meter 52. In the illustrated embodiment, the adapter assembly 56 includes an adapter 58, which is partially disposed about an outlet 60 of the hopper 54 (e.g., disposed about a portion of the outlet 60 of the hopper 54). The adapter 58 is also coupled to the hopper 54 at the outlet 60. In the illustrated embodiment, the adapter 58 is coupled to the hopper 54 by a fastener connection having fasteners 62. The fasteners 62 may include any suitable type(s) of fasteners, such as bolts, screws, rivets, etc. Furthermore, in the illustrated embodiment, the fastener connection includes three fasteners 62. However, in other embodiments, the fastener connection may include more or fewer fasteners (e.g., 1, 2, 4, 5, 6, or more). In addition, while the adapter 58 is coupled to the hopper 54 by a fastener connection in the illustrated embodiment, in other embodiments, the adapter may be coupled to the hopper via other suitable type(s) of connection(s) (e.g., alone or in combination with the fastener connection), such as an adhesive connection, a welded connection (e.g., ultrasonic welded connection, etc.), other suitable type(s) of connection(s), or a combination thereof.

As discussed in detail below, the adapter 58 includes an alignment feature configured to engage a corresponding alignment feature of a receiver 64 (e.g., mounting component). Engagement of the alignment feature of the adapter 58 with the corresponding alignment feature of the receiver 64 positions the receiver 64 relative to the outlet 60 of the hopper 54 with respect to a longitudinal axis 66 and a lateral axis 68. In certain embodiments, the alignment feature of the adapter 58 includes one or more recesses, and the corresponding alignment feature of the receiver 64 includes respective protrusion(s). The recess(es) are configured to receive the protrusion(s) to position the receiver 64 relative to the outlet 60 with respect to the longitudinal axis 66 and the lateral axis 68.

Furthermore, the adapter 58 is coupled to the receiver 64. In the illustrated embodiment, the adapter 58 is coupled to the receiver 64 via a fastener connection having fasteners 70. The fasteners 70 may include any suitable type(s) of fasteners, such as bolts, screws, rivets, etc. Furthermore, in the illustrated embodiment, the fastener connection includes two fasteners 70. However, in other embodiments, the fastener connection may include more or fewer fasteners (e.g., 1, 3, 4, 5, 6, or more). In addition, while the adapter 58 is coupled to the receiver 64 by a fastener connection in the illustrated embodiment, in other embodiments, the adapter may be coupled to the receiver via other suitable type(s) of connection(s) (e.g., alone or in combination with the fastener connection), such as an adhesive connection, a welded connection (e.g., ultrasonic welded connection, etc.), other suitable type(s) of connection(s), or a combination thereof.

The receiver 64 is configured to couple the hopper 54 to the agricultural product meter 52. For example, in certain embodiments, the receiver includes a protrusion configured to be disposed between a pair of protrusions of the agricultural product meter, and the protrusions are configured to receive a pin. While the pin is engaged with the protrusions, the protrusion of the receiver is positioned below the pin, and the protrusions of the agricultural product meter are positioned above the pin. Accordingly, while the pin is engaged with the protrusions, upward movement of the receiver is blocked. Because the receiver is coupled to the hopper via the adapter, upward movement of the hopper is blocked. In addition, due to contact between a bottom surface of the adapter and a top surface of the agricultural product meter, downward movement of the hopper is blocked. Therefore, while the pin is engaged with the protrusions, the receiver couples the hopper to the agricultural product meter. To remove the hopper from the agricultural product meter, the pin may be disengaged from the protrusions, and the hopper may be moved upwardly relative to the agricultural product meter. While a receiver having a protrusion configured to receive a pin is disclosed above, in certain embodiments, the receiver may include other suitable feature(s) configured to couple the hopper to the agricultural product meter.

Furthermore, the receiver 64 includes an alignment feature configured to engage a corresponding alignment feature of the agricultural product meter 52 to position the agricultural product meter 52 relative to the receiver 64, and thus the outlet 60 of the hopper 54, with respect to the longitudinal axis 66 and the lateral axis 68. For example, in the embodiment disclosed above, the alignment feature of the receiver 64 may include the protrusion, and the corresponding alignment feature of the agricultural product meter 52 may include the pair of protrusions configured to engage the protrusion of the receiver 64. Accordingly, engagement of the receiver 64 with the agricultural product meter 52 positions the agricultural product meter 52 relative to the outlet 60 with respect to the longitudinal and lateral axes (e.g., such that the outlet 60 of the hopper 54 is aligned with an inlet of the agricultural product meter with respect to the longitudinal axis 66 and the lateral axis 68). While a receiver alignment feature having a protrusion and an agricultural product meter corresponding alignment feature having a pair of protrusions is disclosed above, in certain embodiments, the alignment feature of the receiver may have any other suitable alignment element(s), and the corresponding alignment feature of the agricultural product meter may have corresponding alignment element(s). Furthermore, while a receiver configured to couple to the agricultural product meter (e.g., receiver configured to couple the hopper to the agricultural product meter) is disclosed above, in certain embodiments, the receiver may be engaged with the agricultural product meter for lateral and longitudinal alignment (e.g., the receiver may not be coupled to the agricultural product meter), and the hopper may be coupled to the agricultural product meter (e.g., via an adjustable connection, such as fastener(s) engaged with slot(s) in a mounting plate).

In the illustrated embodiment, the adapter 58 has a shield 74 configured to block an opening in the agricultural product meter 52. Accordingly, agricultural product flow through the opening is blocked. While the adapter 58 includes the shield 74 in the illustrated embodiment, in other embodiments, the shield may be omitted. For example, in certain embodiments, the hopper may have a shape that covers the opening in the agricultural product meter.

In certain embodiments, the adapter 58 is formed by an injection molding process. Accordingly, the alignment feature, openings for the fasteners 62, and other elements of the adapter may be accurately located. While an injection molded adapter is disclosed herein, in certain embodiments, the adapter may be formed by other suitable process(es) that accurately locate the elements of the adapter, such as a three-dimensional printing process, a machining process, other suitable process(es), or a combination thereof.

A vertical position of the adapter 58 (e.g., position of the adapter 58 with respect to a vertical axis 72) along the outlet 60 is selected based on the vertical positions of the mounting brackets with respect to the hopper 54. As previously discussed, the brackets may be accurately positioned on the hopper 54 with respect to the outlet 60 of the hopper, such that the outlet 60 is accurately located with respect to the row unit frame while the hopper/agricultural product meter assembly is coupled to the frame. By controlling the vertical position of the adapter 58 along the outlet of the hopper 54, the agricultural product meter 52 may be located at an accurate vertical position relative to the frame of the row unit, thereby establishing an accurate vertical alignment between an outlet of the agricultural product meter 52 and an inlet of the agricultural product conveying system. In the illustrated embodiment, the vertical position of the adapter 58 along the outlet 60 is accurately established by accurately positioning openings in the hopper through which the fastener 62 extend. In certain embodiments, the openings may be formed by placing the hopper in a jig, such that the outlet of the hopper is engaged with a mounting feature of the jig. The jig may include apertures that enable a tool to form the openings in the hopper at the locations of the apertures. Furthermore, in certain embodiments, the openings may be formed by a computer controlled tool that forms the openings based on a determined location of the outlet of the hopper. Alternatively, the adapter may be coupled to the hopper at the accurate vertical position via a welded connection (e.g., ultrasonic welded connection), via an adhesive connection, via other suitable type(s) of connection(s), or a combination thereof.

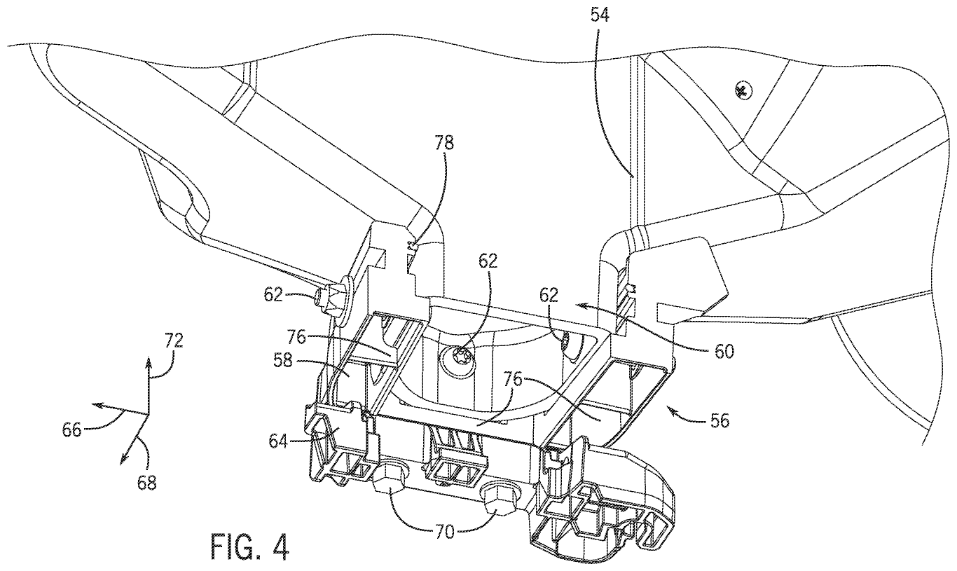

FIG. 4 is a left perspective view of the adapter assembly 56 of FIG. 3. In the illustrated embodiment, the adapter 58 has three legs 76, and each leg 76 is positioned outwardly from a respective outer surface of the outlet 60 of the hopper 54. Accordingly, the receiver 58 is partially disposed about the outlet 60 of the hopper 54. The remaining outer surface of the outlet 60 is disposed against the agricultural product meter. While the adapter 58 has three legs 76 in the illustrated embodiment, in other embodiments, the adapter may have more or fewer legs (e.g., 1, 2, 4, 5, 6, or more). For example, the adapter may have one less leg than the number of outer surfaces of the outlet of the hopper (e.g., to enable the remaining outer surface of the outlet to be disposed against the product meter). Furthermore, in certain embodiments, the adapter may be completely disposed about the outlet of the hopper. Because the adapter 58 is disposed at least partially about the outlet 60 of the hopper 54, the agricultural product may readily flow through the outlet 60 to the agricultural product meter (e.g., as compared to an adapter disposed within the outlet that may interfere with agricultural product flow to the agricultural product meter and/or cause bridging of agricultural product across the outlet). Furthermore, in certain embodiments, the hopper 54 is formed by a rotational molding process. Accordingly, the outer surfaces of the hopper may have greater dimensional accuracy than the inner surfaces. As such, disposing the adapter 58 at least partially about the outlet 60 enables the adapter to be more accurately positioned, as compared to disposing the adapter within the outlet.

In the illustrated embodiment, the adapter assembly 56 includes a seal 78 disposed between the adapter 58 and the outlet 60 of the hopper 54. The seal 78 is configured to block water flow through an interface between the adapter 58 and the hopper 54, thereby blocking water flow into the agricultural product meter. In the illustrated embodiment, the seal 78 includes a single sealing element with a circular cross-sectional shape. However, in other embodiments, the seal may include multiple sealing elements (e.g., 2, 3, 4, 5, or more), and each sealing element may have any suitable cross-sectional shape (e.g., polygonal, elliptical, etc.). Furthermore, in the illustrated embodiment, the seal 78 is disposed within a groove of the adapter 58. However, in other embodiments, the seal may be located using other suitable element(s) (e.g., protrusions, plates, etc.).

As previously discussed, the adapter 58 is coupled to the hopper 54 via the fasteners 62. In the illustrated embodiment, a fastener 62 extends through a respective opening within each leg of the adapter 58 and through a respective opening within each outer surface of the outlet 60 of the hopper 54. Accordingly, engaging (e.g., tightening) the fasteners 62 drives the legs 76 of the adapter 58 toward the respective outer surfaces of the outlet 60, thereby compressing the seal between the legs 76 and the outer surfaces of the outlet 60. Furthermore, because the heads of the fasteners 62 are rounded/curved, the heads of the fasteners may facilitate flow of the agricultural product through the outlet 60 to the agricultural product meter. In the illustrated embodiment, the seal 78 is partially disposed about the outlet 60 (e.g., the seal 78 is engaged with three outer surfaces of the outlet 60). However, in other embodiments (e.g., in embodiments in which the adapter is entirely disposed about the outlet), the seal may be entirely disposed about the outlet (e.g., the seal may be engaged with four outer surfaces of the outlet). Furthermore, in certain embodiments, the seal may be omitted. In such embodiments, the legs of the adapter may be disposed against the respective outer surfaces of the outlet (e.g., compressed against the outer surfaces of the outlet by the fasteners), and, in certain embodiments, the adapter may be formed from a semi-rigid material (e.g., polymeric material) configured to establish a seal against the outer surfaces of the outlet.

As previously discussed, the adapter 58 includes an alignment feature configured to engage a corresponding alignment feature of the receiver 64 to position the receiver relative to the outlet 60 with respect to the longitudinal axis 66 and the lateral axis 68. In addition, the adapter 58 is coupled to the receiver 64. For example, the adapter 58 may include opening(s) configured to receive the fastener(s) 70 to couple the adapter 58 to the receiver 64. In certain embodiments, the receiver 64 is configured to be used to couple other hoppers to the agricultural product meter (e.g., hoppers formed by an injection molding process). For example, another hopper may include an alignment feature configured to engage the corresponding alignment feature of the receiver (e.g., in which the alignment feature of the hopper is accurately located because the hopper is formed by an injection molding process), and the hopper may include opening(s) configured to receive the fastener(s) to couple the hopper to the receiver (e.g., in which the opening(s) are accurately located because the hopper is formed by an injection molding process). Accordingly, the receiver may be used to couple another hopper to the agricultural product meter without the use of an adapter. The adapter 58 enables a hopper 54 with dimensional variations (e.g., a hopper formed by a rotational molding process) to be used with the same receiver 64 (e.g., receiver configured to couple to a hopper formed by an injection molding process), thereby reducing costs associated with designing and manufacturing different receivers for different hoppers.

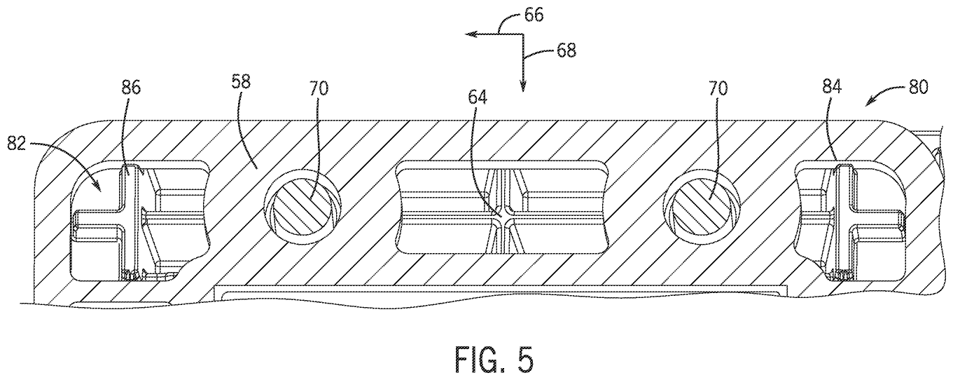

FIG. 5 is a cross-sectional view of the adapter assembly 56 of FIG. 3. As previously discussed, the adapter 58 includes an alignment feature 80 configured to engage a corresponding alignment feature 82 of the receiver 64 to position the receiver 64 relative to the outlet of the hopper with respect to the longitudinal axis 66 and the lateral axis 68. In the illustrated embodiment, the alignment feature 80 of the adapter 58 includes two recesses 84, and the corresponding alignment feature 82 of the receiver 64 includes two protrusions 86. While the alignment feature 80 of the adapter 58 includes two recesses 84 in the illustrated embodiment, in other embodiments, the alignment feature of the adapter may include more or fewer recesses, and the corresponding alignment feature of the receiver may include a corresponding number of protrusions. Furthermore, in certain embodiments, the alignment feature of the adapter may include one or more protrusions (e.g., alone or in combination with the recess(es)), and the corresponding alignment feature of the receiver may include respective recess(es) (e.g., alone or in combination with the protrusion(s)). In addition, in certain embodiments, the alignment features may include other suitable alignment elements (e.g., alone or in combination with the protrusion(s)/recess(es)).

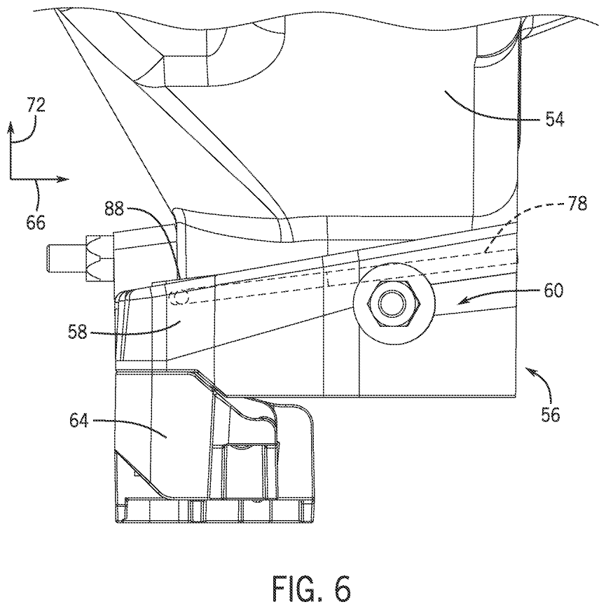

FIG. 6 is a side view of a portion of the adapter assembly 56 of FIG. 3. In the illustrated embodiment, a top surface 88 of the adapter 58 is angled downwardly away from the agricultural product meter to direct water away from the agricultural product meter. As a result, water flow into the agricultural product meter may be reduced. Furthermore, in the illustrated embodiment, the seal 78 (e.g., each laterally extending portion of the seal) is angled downwardly away from the agricultural product meter to direct water away from the agricultural product meter. As a result, water flow into the agricultural product meter may be reduced. While the top surface of the adapter is angled downwardly away from the agricultural product meter in the illustrated embodiment, in other embodiments, the top surface may be angled in another suitable direction. Furthermore, while the seal is angled downwardly away from the agricultural product meter in the illustrated embodiment, in other embodiments, the seal may be angled in another suitable direction. For example, in certain embodiments, the top surface of the adapter and/or the seal may be within a plane formed by the lateral axis and the longitudinal axis.

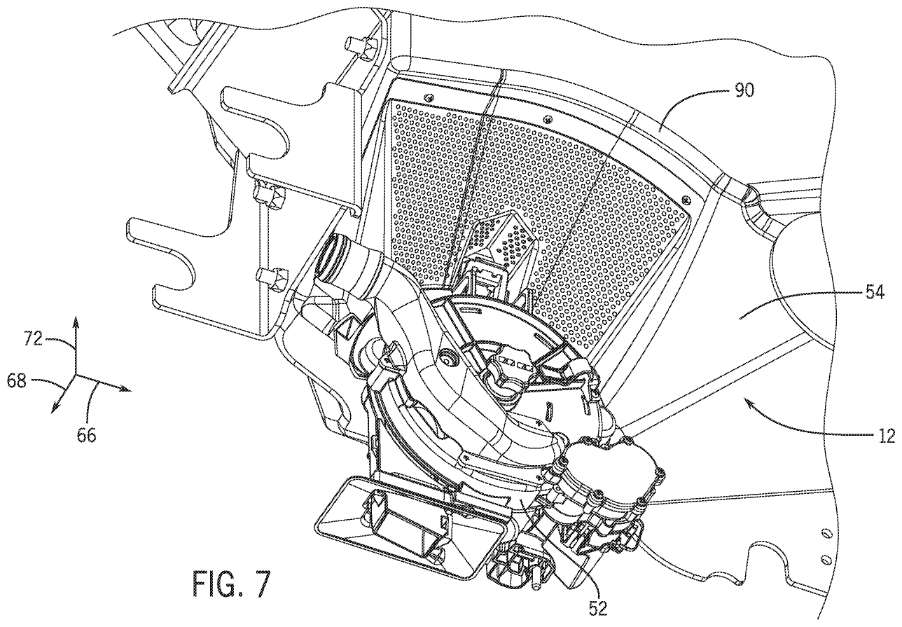

FIG. 7 is a perspective view of a portion of the row unit 12 of FIG. 2. As previously discussed, the seal is engaged with three outer surfaces of the outlet of the hopper 54. In addition, the remaining outer surface is disposed against the agricultural product meter. In the illustrated embodiment, water flow through the interface between the remaining outer surface and the agricultural product meter is blocked by a ledge 90 of the hopper 54. Accordingly, water flow into the agricultural product meter may be substantially reduced.

While the row unit includes a receiver in the embodiments disclosed above, in certain embodiments, the receiver may be omitted. In such embodiments, the adapter may be configured to engage the agricultural product meter (e.g., mounting component). For example, in certain embodiments, the adapter includes an alignment feature configured to engage a corresponding alignment feature of the agricultural product meter to position the agricultural product meter relative to the outlet of the hopper with respect to the longitudinal axis and the lateral axis (e.g., such that the outlet of the hopper is aligned with the inlet of the agricultural product meter with respect to the longitudinal axis and the lateral axis). By way of example, the alignment feature of the adapter may include a protrusion, such as the protrusion disclosed above with regard to the receiver, and the corresponding alignment feature of the agricultural product meter may include a pair of protrusions configured to engage the protrusion of the adapter. Accordingly, engagement of the adapter with the agricultural product meter positions the agricultural product meter relative to the outlet with respect to the longitudinal and lateral axes (e.g., such that the outlet of the hopper is aligned with an inlet of the agricultural product meter with respect to the longitudinal axis and the lateral axis). While an adapter alignment feature having a protrusion and an agricultural product meter corresponding alignment feature having a pair of protrusions is disclosed above, in certain embodiments, the alignment feature of the adapter may have any other suitable alignment element(s), and the corresponding alignment feature of the agricultural product meter may have corresponding alignment element(s).

Furthermore, in certain embodiments, the adapter is configured to couple to the agricultural product meter (e.g., via a pin, such as the pin disclosed above with regard to coupling the receiver to the agricultural product meter, via fastener(s), such as the fastener(s) disclosed above with regard to coupling the receiver to the adapter, etc.). For example, the adapter may include opening(s) configured to receive fastener(s) configured to couple the adapter to the agricultural product meter. However, in other embodiments, the adapter may be engaged with the agricultural product meter for lateral and longitudinal alignment (e.g., the adapter may not be coupled to the agricultural product meter), and the hopper may be coupled to the agricultural product meter (e.g., via an adjustable connection, such as fastener(s) engaged with slot(s) in a mounting plate).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An adapter assembly for a hopper of an agricultural row unit, comprising:
an adapter configured to be disposed at least partially about an outlet of the hopper, wherein the adapter is movable along the outlet of the hopper to a vertical position to establish vertical alignment between an outlet of an agricultural product meter and an inlet of an agricultural product conveying system, the adapter is configured to be coupled to the hopper at the vertical position along the outlet of the hopper, the adapter comprises an alignment feature configured to engage a corresponding alignment feature of a mounting component to position the mounting component relative to the outlet of the hopper with respect to a longitudinal axis and a lateral axis;
wherein the mounting component comprises the agricultural product meter or a receiver configured to engage the agricultural product meter.

2. The adapter assembly of claim 1, wherein the adapter has three legs configured to be positioned outwardly from three respective outer surfaces of the outlet of the hopper.

3. The adapter assembly of claim 1, wherein a top surface of the adapter is angled downwardly to direct water away from the agricultural product meter.

4. The adapter assembly of claim 1, comprising a seal configured to be disposed between the adapter and the outlet of the hopper to block water flow through an interface between the adapter and the hopper.

5. The adapter assembly of claim 4, wherein the seal is angled downwardly to direct water away from the agricultural product meter.

6. The adapter assembly of claim 1, comprising a plurality of fasteners configured to extend through a plurality of openings within the adapter to couple the adapter to the hopper.

7. The adapter assembly of claim 1, wherein the alignment feature of the adapter comprises a recess configured to receive a protrusion of the corresponding alignment feature of the mounting component.

8. The adapter assembly of claim 1, wherein the adapter is configured to couple to the mounting component.

9. The adapter assembly of claim 8, wherein the adapter comprises an opening configured to receive a fastener configured to couple the adapter to the mounting component.

10. The adapter assembly of claim 1, wherein the adapter comprises a shield configured to block an opening in the agricultural product meter.

11. An agricultural row unit, comprising:
an agricultural product meter having an outlet;
a hopper having an outlet; and
an adapter assembly, comprising:
an adapter disposed at least partially about the outlet of the hopper, wherein the adapter is movable along the outlet of the hopper to a vertical position to establish vertical alignment between the outlet of the agricultural product meter and an inlet of an agricultural product conveying system, the adapter is configured to be coupled to the hopper at the vertical position along the outlet of the hopper, the adapter comprises an alignment feature configured to engage a corresponding alignment feature of a mounting component to position the mounting component relative to the outlet of the hopper with respect to a longitudinal axis and a lateral axis;
wherein the mounting component comprises the agricultural product meter or a receiver configured to engage the agricultural product meter.

12. The agricultural row unit of claim 11, wherein the adapter assembly comprises a seal configured to be disposed between the adapter and the outlet of the hopper to block water flow through an interface between the adapter and the hopper.

13. The agricultural row unit of claim 11, wherein the adapter assembly comprises a plurality of fasteners configured to extend through a plurality of openings within the adapter to couple the adapter to the hopper.

14. The agricultural row unit of claim 11, wherein the alignment feature of the adapter comprises a recess configured to receive a protrusion of the corresponding alignment feature of the mounting component.

15. The agricultural row unit of claim 11, wherein the adapter comprises a shield configured to block an opening in the agricultural product meter.

16. A method of manufacturing an agricultural row unit, comprising:
selecting a vertical position of an adapter along an outlet of a hopper to establish vertical alignment between an outlet of an agricultural product meter and an inlet of an agricultural product conveying system;
disposing the adapter at least partially about the outlet of the hopper;
coupling the adapter to the hopper at the vertical position along the outlet of the hopper; and
engaging an alignment feature of the adapter with a corresponding alignment feature of a mounting component to position the mounting component relative to the outlet of the hopper with respect to a longitudinal axis and a lateral axis, wherein the mounting component comprises the agricultural product meter or a receiver configured to engage the agricultural product meter.

17. The method of claim 16, wherein selecting the vertical position of the adapter comprises forming a plurality of openings in the outlet of the hopper, and coupling the adapter to the hopper comprises disposing a plurality of fasteners through the plurality of openings.

18. The method of claim 16, wherein the alignment feature of the adapter comprises a recess configured to receive a protrusion of the corresponding alignment feature of the mounting component.

19. The method of claim 16, comprising coupling the adapter to the mounting component.

20. The method of claim 16, wherein a top surface of the adapter is angled downwardly to direct water away from the agricultural product meter.
